(19) United States
(12) Patent Application Publication
(10) Pub. No.: US 2007/0096545 A1
(43) Pub. Date: May 3, 2007

(54) Structure of wheel rim cover

(75) Inventor: Ming-Fang Wang, Tainan Hsien (TW)

Correspondence Address: BACON & THOMAS, PLLC, 625 SLATERS LANE, FOURTH FLOOR, ALEXANDRIA, VA, 22314, US

(73) Assignee: Kuan Hsings Enterprise Corp., Tainan Hsien (TW)

(21) Appl. No.: 11/272,669

(22) Filed: Nov. 15, 2005

(30) Foreign Application Priority Data
Nov. 1, 2005 (TW) 094218884

(51) Int. Cl. B60B 7/00

(52) U.S. Cl. 301/37.42

(57) ABSTRACT

A wheel rim covering structure of the invention includes: one cover body, which has a cover surface and ring spoke edge is formed on it. Many costal bodies and engraved holes are sit on the cover surface, and the shrinking hole edge of each engraved hole would form an end hole at the backside of the cover surface. The hole edge is equipped with a plastic made fastener assembly which was formed as one with the cover body. Such fastener assembly each has a suitable length stem. A buckling part would be set at one end of the stem to co-surround to establish the first ring diameter and has the first height, from ring spoke edge to the end of the fastener assembly part. By means of stem of the fastener assembly extends into the engraved holes of wheel rim and the buckling part would buckle up the inner edge of each engraved hole respectively. Hence, the whole wheel rim cover body could be poisoned stably.

### BACKGROUND OF THE INVENTION

1. Field of the Invention

This invention relates to a structure of rim cover, especially for the wheel rim cover which was formed as one body and with fastener assembly without coil spring, and its structure is suitable for covering on the outer surface of the rim and is embedded-buckling positioned via the engraved hole on the rim.

2. Description of the Related Art

For covering bad-looking surface, traditional steel rim would make use of wheel cover to cover its surface, e.g. U.S. Pat. No. 5,772,287, U.S. Pat. No. 6,033,033. Mainly, it make use of the fasteners which sit at the back side circumference of the arc external convex cover face of the wheel rim cover to insert at the inner circumference of the outmost specific arc concave to be positioned. However, when aluminum alloy wheel rim surface has been scratched, it would be difficult to be covered by the above-named wheel rim cover; since, on an aluminum alloy wheel rim, there is not a specific arc concave inner circumference co-supported by such fastener assembly.

Nowadays, for such cover, the trade set fastener assembly at the position approaching engraved holes at the back side of the cover body to make use of fasteners' inserting in the inner circumference of the engraved holes of the aluminum alloy wheel rim, e.g. case TW-M275112. However, the design of TW-M275112 still uses wheel rim cover arc outward convex cover surface applied on traditional steel wheel rim; and this causes that a redundant cover body engraved hole ring edge must be designed for enabling fastener assembly to buckle the inner circumference of the engraved hole of the aluminum alloy wheel rim. This design make the cover body model become bulky and ruin the taste of the aluminum alloy wheel rim. In addition, case TW-M262380, the design of concave cover surface shortens the cover body engraved hole ring edge, but its fastener assembly must be equipped with a fix base with slot and an external embedded metal reed, and this cause the structure become complicated and inconvenient. As for the new model patent application case TW93215498, every fastener assembly sit at outside of the same end hole of the engraved hole of the backside of the cover body will be co-supported-and-stretched-out by one coil spring and hook up at the end hole of the engraved hole of the aluminum alloy wheel rim. It is practical, but supported and stretched out by coil spring would increase manufacture cost and complicate the assembling processes. Hence, the practicality is still not ideal enough.

### SUMMARY OF THE INVENTION

The objective of this invention is to provide an improved wheel rim covering structure, which includes: one cover body, which has a cover surface and ring spoke edge formed around the cover surface circumference. Many costal bodies sit on the cover surface, and engraved hole is formed between two costal bodies. Every engraved hole establishes an extended shrinking hole edge from cover surface to backside, and each forms an end hole at the backside. The outer hole edge of the near end hole of each engraved hole at the backside of the cover body is equipped with a fastener assembly which was formed as one with the cover body. Such fastener assembly each is corresponding to face the center of cover body; besides, it would be set at the hole edge closing spoke edge at the end hole and each should has a suitable length stem. A fastening part of the outward convex buckling part would be set at one end of the stem; each fastener assembly outward convex buckling part would co-surround to establish the first ring diameter and has the first height, from ring spoke edge to the end of the fastener assembly part. The cover body and fastener assembly both are made of plastic material. By means of the above-named structures, stem of each fastener assembly of the cover body can extend into the engraved holes of aluminum alloy wheel rim and the fastener assembly outward convex buckling part would buckle up the inner edge of the first buckling edge of each engraved hole respectively. Hence, the whole wheel rim cover body could be poisoned stably.

### BRIEF DESCRIPTION OF THE DRAWINGS

Other features and advantages of the present invention will become apparent in the following detailed description of the preferred embodiments, with reference to the accompanying drawings, in which:

FIG. 1 is a facade structure diagram of the invention preferred embodiments.

FIG. 2 is an A-A section diagram of the FIG. 1.

FIG. 3 is a backside structure diagram of the invention preferred embodiments.

FIG. 4 is an enlarged diagram of the fastener assembly of the invention preferred embodiments.

FIG. 5 is a separate cross-section diagram of the invention preferred embodiments, before installing with the aluminum alloy wheel rim.

FIG. 6 is a cross-section diagram of the invention preferred embodiments, after installing with the aluminum alloy wheel rim.

FIG. 7 is a facade structure diagram of the invention second preferred embodiments.

FIG. 8 is an B-B section diagram of the FIG. 1.

FIG. 9 is an enlarged diagram of the fastener assembly of the invention second preferred embodiments.

FIG. 10 is a cross-section diagram of the invention second preferred embodiments, after installing with the aluminum alloy wheel rim.

### DETAILED DESCRIPTION OF THE PREFERRED EMBODIMENTS

In the detailed description of the preferred embodiments, it should be noted that like elements are indicated by the same reference numerals throughout the disclosure.

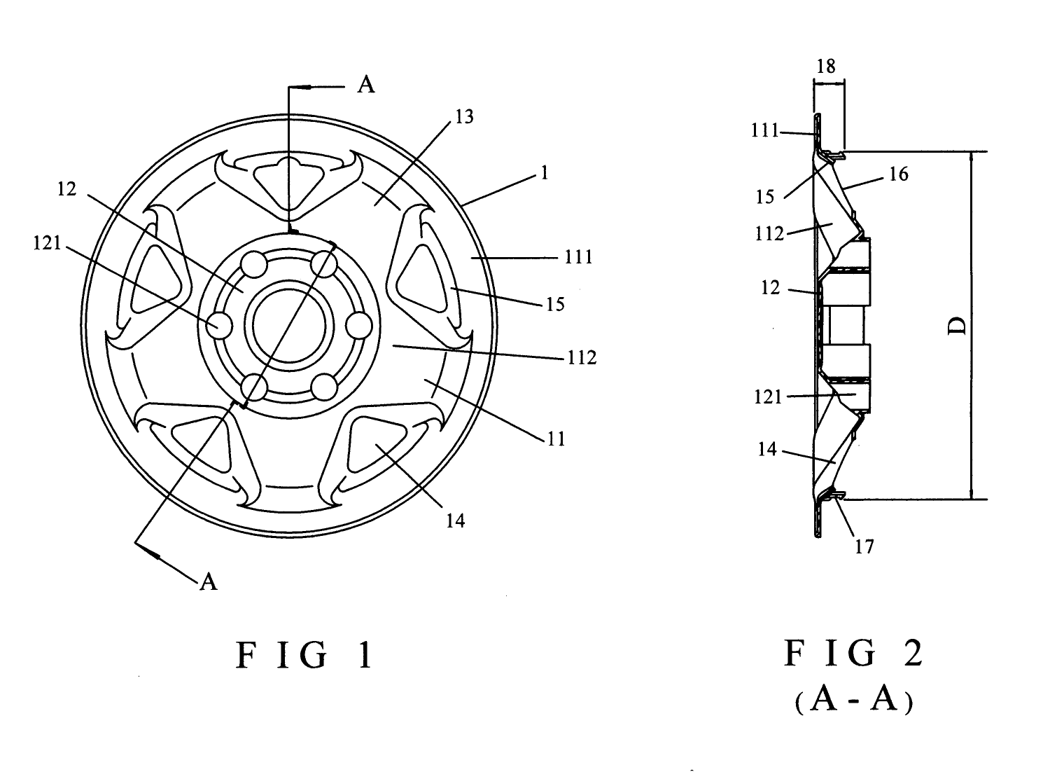

Referring to FIG. 1 and FIG. 2, the invention preferred embodiments includes:

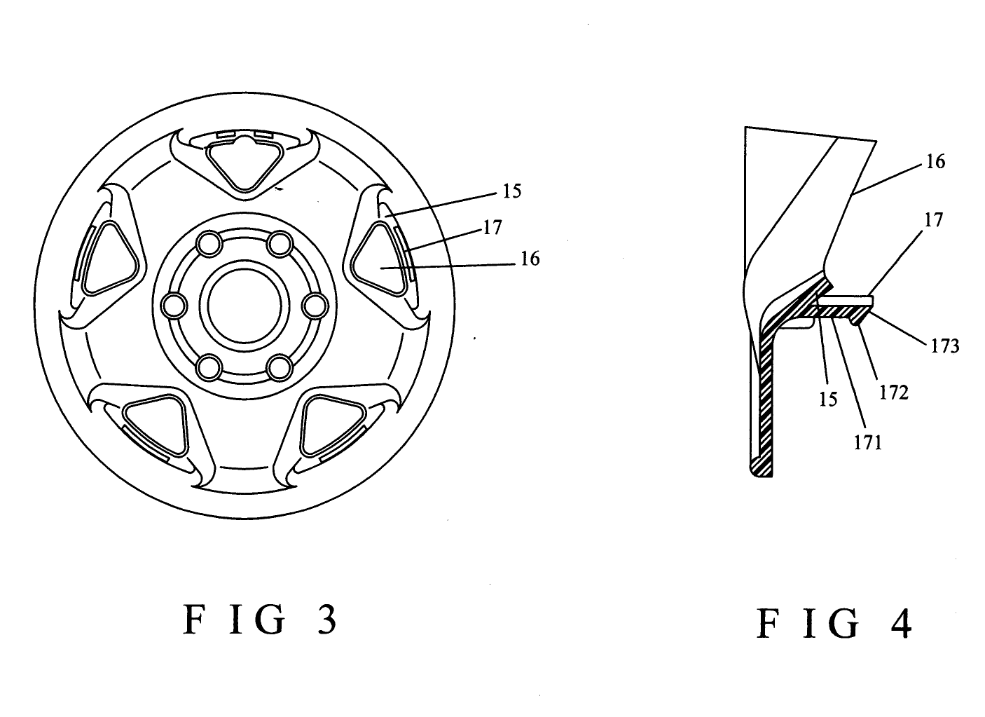

One cover body 1 has a cover surface 11 and cover surface 11 circumference forms ring spoke edge 111. The cover surface 11 is inward concaved to form a ring ramp 112, and an inclined concave is formed from spoke edge 111 to center and, at the center, establishes a convex shaft lid 12 whose direction is opposite to the concave ring ramp 112. Many engraved holes 121 are deployed on shaft lid as a ring, and many costal bodies 13 sit on the concave ring ramp of the cover surface 11. Engraved hole 14 would be formed between two costal bodies 13, and each engraved hole has its specific shape and externally establishes shrinking hole edge 15, from cover surface 11 façade to backside, to form an end hole 16 at the backside of the cover surface 11 respectively. Referring to FIG. 3 and FIG. 4, fastener assembly 17 which is formed as one with cover body 1 is equipped at the outer hole edge 15 of the near end hole 16 of engraved hole 14 at the backside of the cover body 11. Such fastener assembly 17, each is corresponding to face the center of cover body 1; besides, it would be set at the hole edge 15 closing spoke edge 111 at the end hole 16 and each should has a suitable length stem 171. A fastening part 173 of the outward convex buckling part 172 would be set at one end of the stem 117; each outward convex buckling part 172 of the fastener assembly 17 would co-surround to establish the first ring diameter D. The cover body and fastener assembly both are made of plastic material. Every fastener assembly 17 depending on the shapes of engraved hole 14 and end hole 16 to have different setting position, separating distance and amount, and at the same time, forms the first height 18 which is from ring spoke edge 12 to the end of the fastening part 173. Both cover body 1 and fastener assembly are made of plastic material. The fastener assembly 17 has a suitable elasticity caused by the length of stem 171. Hence, in the first ring diameter D, there is not any coil spring similar to known technology, except the fastening part 173 of each fastener assembly 17.

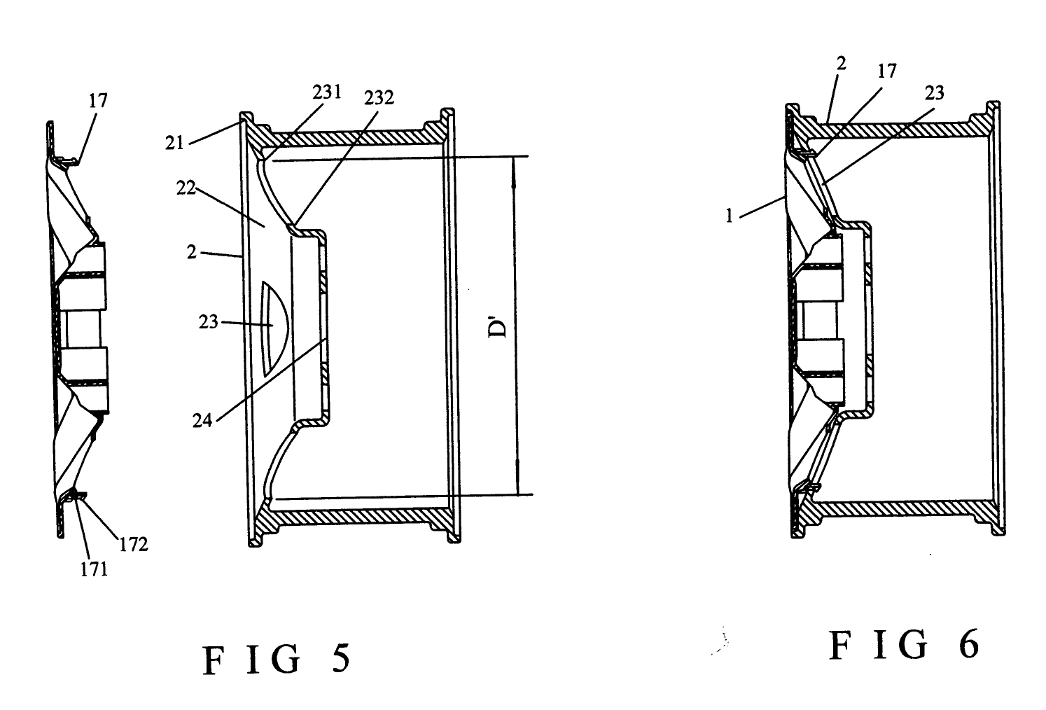

Referring to FIG. 5 and FIG. 6, the invention preferred embodiment, the aluminum alloy wheel rim 2, has a projecting circumference 21 sit outer side of its periphery and a wheel face 22 whose inner concave form a slightly ring ramp. There are many specific types and models of engraved holes 23 on wheel face 22 and a shaft hole 24 at the center of wheel face 22. Since engraved holes sit on the ramp, the first buckling edge 231, closer to circumference 21, sit at higher position and the second buckling edge 232, closer to shaft hole 24, sit at lower position are formed. When install the wheel rim cover—the invention preferred embodiment, make the stem 171 of every fastener assembly 17 of the cover body 1 stretch into engraved holes 23. Since the first ring diameter D co-surrounded by the convex buckling part 172 of every fastener assembly 17 is slightly larger than the diameter D′ co-surrounded by buckling edge 231 of closer circumference 21 of every engraved hole 23 of the aluminum alloy wheel rim 2, when stem 171 of fastener assembly 17 stretches into engraved hole 23, it will be slightly blocked. After every buckling part 172 stretching and passing the diameter D′ co-surrounded by buckling edge 231 of every engraved hole 23, the convex buckling part 172 of every fastener assembly 17 would buckle up the inner edge of the first buckling edge 231 of every engraved hole 23 to make the whole wheel rim cover be positioned stably.

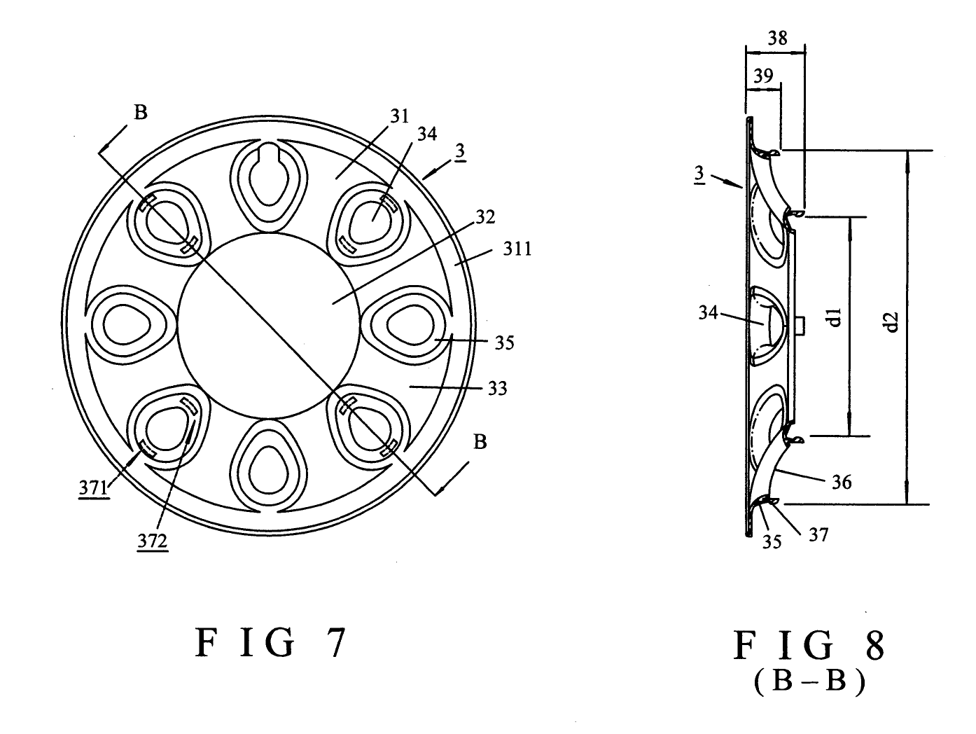

Referring to FIG. 7 and FIG. 8, the invention second preferred embodiments includes:

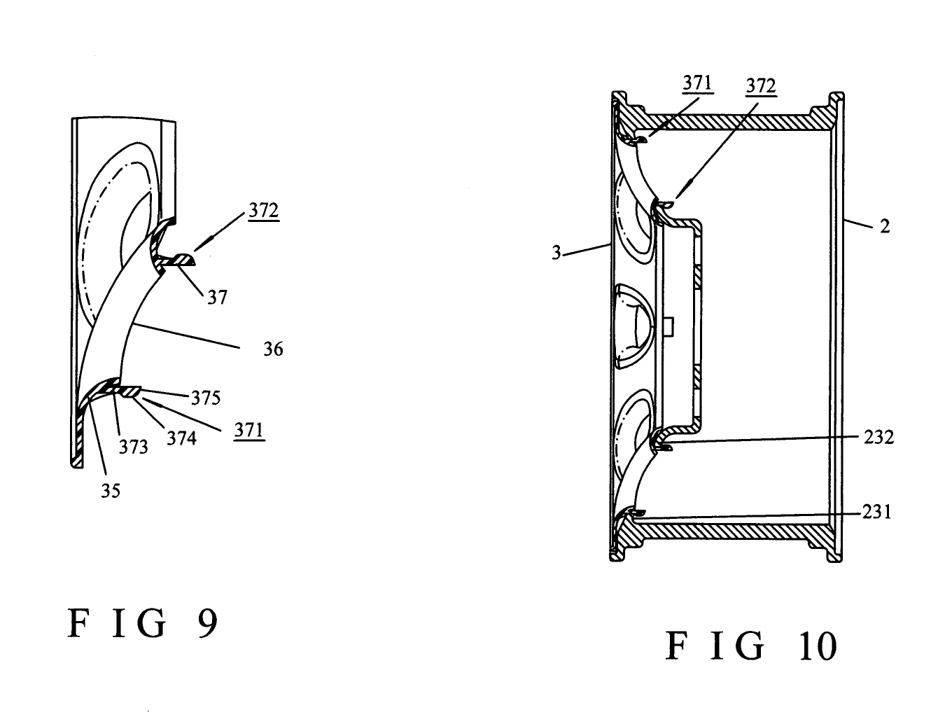

One cover body 3 has a cover surface 31 and cover surface 31 circumference forms ring spoke edge 311. The cover surface 31 is inward concaved to form a ring ramp 312, and an inclined concave is formed from spoke edge 311 to center and, at the center, establishes a huge engraved hole area 32. Many costal bodies 33 are sit on the concave ring ramp of the cover surface 31. Engraved hole 34 would be formed between two costal bodies 33, and, referring to FIG. 8, each engraved hole has its specific shape and externally establishes shrinking hole edge 35, from cover surface 31 façade to backside, to form an end hole 36 at the backside of the cover surface 31 respectively. Referring to FIG. 9, fastener assembly 37 which is formed as one with cover body 3 is equipped at the outer hole edge 35 of the near end hole 36 of engraved hole 34 at the backside of the cover body 31. Such fastener assembly 37 includes the first group of fastener assembly 371, each is corresponding to face the center of cover body 3; besides, it would be set at the hole edge 35 closing to spoke edge 311 at the end hole 36 and the second group of fastener assembly 372, each is corresponding to face the spoke edge 311 of cover body 3; besides, it would be set at the hole edge 35 closing to ring cover face 31 center at the end hole 36. Each group of fastener assembly should has a suitable length stem 373. A fastening part 375 of the outward convex buckling part 374 would be set at one end of the stem 373; each outward convex buckling part 374 of the first group of fastener assembly 371 would co-surround to establish the first ring diameter d1 and each outward convex buckling part 374 of the second group of fastener assembly 372 would co-surround to establish the second ring diameter d2, the first ring diameter d1>the second ring diameter d2. Every fastener assembly 37 depending on the shapes of engraved hole 34 and end hole 36 to have different setting position, separating distance and amount. Every fastener assembly of the first group of fastener assemblies 371 has the first height 38 which is from ring spoke edge 32 to the end of the fastening part 375. Every fastener assembly of the second group of fastener assemblies 372 has the first height 39 which is from ring spoke edge 32 to the end of the fastening part 375. The second height 39 is bigger than the first height 38. Both cover body 1 and fastener assembly are made of plastic material. The fastener assembly 37 has a suitable elasticity caused by the length of stem 371. Hence, between the first ring diameter d1 and the second ring diameter d2, there is not any coil spring similar to known technology, except the fastening part 375 of each fastener assembly 37; between the fastener assemblies 37 of the first ring diameter d1 and the second ring diameter d2 at both sides of the same end hole 36, there is not any coil spring similar to known technology.

Referring to FIG. 10, the invention second preferred embodiment, when installing the wheel rim cover on the aluminum alloy wheel rim 2, make the stem 373 of every fastener assembly 37 of the cover body 3 stretch into engraved holes 23. Since the first ring diameter d1 co-surrounded by the convex buckling part 374 of every fastener assembly 37 of the first group of fastener assemblies 371 is slightly larger than the diameter D′ co-surrounded by every the first buckling edge 231 of closer circumference 21 of every engraved hole 23 of the aluminum alloy wheel rim 2, and the first ring diameter d1 co-surrounded by the convex buckling part 374 of every fastener assembly 37 of the second group of fastener assemblies 372 is slightly smaller than the diameter D″ co-surrounded by every the second buckling edge 232 of closer center shaft hole 24 of every engraved hole 23 of the aluminum alloy wheel rim 2. When stem 373 of every fastener assembly 37 stretches into engraved hole 23, it will be slightly blocked. After every buckling part 374 stretching and passing the diameter D′ and D″ co-surrounded by the first buckling edge 231 and the second buckling edge of every engraved hole 23, the convex buckling part 374 of every fastener assembly 37 would buckle up the inner edge of the first buckling edge 231 and the second buckling edge 232 of every engraved hole 23 to make the whole wheel rim cover be positioned stably.

Of the invention preferred embodiment, every fastener assembly of the wheel rim cover is formed as one with the cover body, and this save lots of cost of manufacture and assembly. Besides, stem of the fastener assembly offer excellent elasticity and can buckle up on the engraved hole 23 of the aluminum alloy wheel rim 2 directly; no well known coil spring is necessary. Even two group of fastener assemblies 371 and 372 forming two different height, well buckling-up can be completed.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A wheel rim cover structure includes:
a cover body, which has a cover surface and ring spoke edge formed around the cover surface circumference; many costal bodies sit on the cover surface, and engraved hole is formed between two costal bodies; every engraved hole establishes an extended shrinking hole edge from cover surface to backside, and each forms an end hole at the backside; the outer hole edge of the near end hole of each engraved hole at the backside of the cover body is equipped with a fastener assembly which was formed as one with the cover body; such fastener assembly each is corresponding to face the center of cover body; besides, it would be set at the hole edge closing spoke edge at the end hole and each should has a suitable length stem; a fastener assembly part of the outward convex buckling part would be set at one end of the stem; each fastener assembly outward convex buckling part would co-surround to establish the first ring diameter and has the first height, from ring spoke edge to the end of the fastener assembly part; the cover body and fastener assembly both are made of plastic material; by means of above-named structures, stem of each fastener assembly of the cover body can extend into the engraved holes of aluminum alloy wheel rim and the fastener assembly outward convex buckling part would buckle up the inner edge of the first buckling edge of each engraved hole respectively; hence, he whole wheel rim cover body could be poisoned stably.

2. A wheel rim structure as claimed in claim 1, wherein said cover surface is inner concaved to form a ring ramp and inclined concave from spoke edge to center.

3. A wheel rim structure as claimed in claim 1, wherein said cover surface for a convex shaft lid at the center.

4. A wheel rim structure as claimed in claim 3, wherein said many engraved holes are deployed on the shaft lid as a ring.

5. A wheel rim structure as claimed in claim 1, wherein said a huge engraved area at the center of the cover surface.

6. A wheel rim structure as claimed in claim 1, wherein said in the first ring diameter, there is not any coil spring except the fastening part of each fastener assembly.

7. A wheel rim structure as claimed in claim 1, wherein said such fastener assembly includes: the first group of fastener assemblies, every corresponding to face center of cover body and set at the side of hole edge closing to spoke edge of every end hole, and the second group of fastener assemblies, every corresponding to face spoke edge of cover body and set at the side of hole edge closing to ring cover surface of every end hole.

8. A wheel rim structure as claimed in claim 7, wherein said first ring diameter is co-surrounded by outward convex buckling part of every fastener assembly of the first group of fastener assemblies and the second ring diameter is co-surrounded by outward convex buckling part of every fastener assembly of the second group of fastener assemblies. In addition, the first ring diameter is bigger than the second ring diameter.

9. A wheel rim structure as claimed in claim 7, wherein said, of the first group of fastener assemblies, every fastener assembly has the first height which is from ring spoke edge to the end of the fastening part, and of the second group of fastener assemblies, every fastener assembly has the second height which is from ring spoke edge to the end of the fastening part. In addition, the second height is larger than the first height.

10. A wheel rim structure as claimed in claim 1, wherein said cover body and fastener assembly both are made of plastic material.

11. A wheel rim structure as claimed in claim 8, wherein said between the first and the second ring diameters, there is not any coil spring, except the fastening part of the fastener assembly.

12. A wheel rim structure as claimed in claim 7, wherein said between the first and the second ring diameters at both sides of the same end hole, there is not any coil spring.
